(19) United States
(12) Patent Application Publication
(10) Pub. No.: US 2026/0350732 A1
(43) Pub. Date: Nov. 5, 2026

(54) SYSTEM AND METHOD FOR OPTIMIZING ACADEMIC PATHWAY TO ACHIEVE ACADEMIC GOALS

(71) Applicants: Sanjay Raj, Dublin, CA (US); Sahira Raj, Dublin, CA (US)

(72) Inventors: Sanjay Raj, Dublin, CA (US); Sahira Raj, Dublin, CA (US)

(73) Assignees: Sanjay Raj, Dublin, CA (US); Sahira Raj, Dublin, CA (US)

(21) Appl. No.: 19/197,994

(22) Filed: May 3, 2025

(51) Int. Cl. G06Q 50/20; G06F 40/30

(52) U.S. Cl. CPC G06Q 50/2053; G06F 40/30

(57) ABSTRACT

One or more embodiments of the present disclosure relate to a system and method (together termed as mechanism) optimizing academic pathway for a user to achieve academic goals. The mechanism includes receiving user data associated with the user. Further, the mechanism includes extracting course metadata from the user data. Furthermore, the mechanism includes analyzing the extracted course metadata to determine course requirements that the user has not yet fulfilled to achieve the academic goal. Moreover, the mechanism includes mapping each of the determined course requirements to equivalent courses across a plurality of educational institutions. Additionally, the mechanism includes sequencing the equivalent courses associated with each of the determined course requirements in a logical order. Also, the mechanism includes optimizing an academic pathway for the sequenced equivalent courses and rendering the optimized pathway on a user device.

### BACKGROUND

### Technical Field

The present disclosure relates to academic advising and curriculum planning solutions and in particular, relates to a system and method for optimizing academic pathway to achieve academic goals.

### Description of the Related Art

Traditional academic advising and academic planning systems lack the intelligence, adaptability, and efficiency required to guide students toward completing their academic goals effectively. Students who wish to pursue a specific degree or academic pathway often struggle to determine the best way to achieve their goals within the constraints of institutional requirements, course availability, scheduling conflicts, and personal circumstances. The existing systems for academic planning rely heavily on manual efforts, fragmented information sources, and static advising models, making it difficult for students to develop an optimized academic plan that aligns with their long-term objectives.

Currently, students must navigate multiple disconnected platforms, such as institutional course catalogs, credit transfer guides, and academic advising portals, to manually piece together a pathway toward graduation. These systems do not offer a unified, structured approach to planning coursework, leading to inefficiencies such as enrolling in unnecessary courses, delaying prerequisite completion, or failing to meet graduation requirements within the desired timeframe. Additionally, most advising systems do not offer dynamic planning tools that allow students to visualize multiple academic pathways, compare different scenarios, or adjust their plans based on changes in institutional policies, course offerings, or personal preferences.

Course scheduling is another major challenge in traditional academic advising. Students often have to manually check course availability across multiple terms, institutions, and delivery modes (e.g., in-person, online, hybrid) to fit their schedules. Scheduling conflicts, limited course seats, and inconsistent prerequisite structures further complicate the process, resulting in delayed academic progress. Furthermore, students who need to take courses at multiple institutions simultaneously, such as those enrolled in community colleges planning to transfer to universities, have no structured way to plan their coursework across different academic calendars and institutional policies.

While some institutions provide basic academic advising tools, these systems are often limited to static degree progress checklists or rule-based course recommendations that do not dynamically adjust based on real-time changes in course availability, institutional policies, or student preferences. Additionally, traditional systems lack predictive analytics to help students anticipate potential obstacles, such as bottleneck courses with limited seats, prerequisite sequencing issues, or time constraints that may extend their time to graduation.

As higher education becomes increasingly flexible and students seek personalized learning pathways, there is a growing need for a system and method for optimizing academic pathway for a user to achieve academic goals and address the above-mentioned drawbacks.

### BRIEF SUMMARY

One or more embodiments are directed to a system and method for optimizing academic pathway for a user to achieve academic goals. User data, including course completion records, academic objectives, and personalized conditions, is received. Course metadata comprising course descriptions, learning outcomes, and prerequisite dependencies is extracted from the received course completion data and academic goal data. The extracted data is analyzed to determine outstanding course requirements using natural language processing techniques, including named entity recognition and semantic analysis.

In an embodiment, course requirements are mapped to equivalent courses across multiple educational institutions. The mapping process utilizes knowledge graphs, NLP-based equivalency mapping, and credit structure comparisons. The identified courses are then sequenced in a logical order by arranging them to satisfy prerequisite dependencies, co-requisites, and credit load balance across academic terms. The sequencing ensures compliance with institutional scheduling constraints, including course availability and enrolment limits. Rolling time window constraints may be applied to ensure prerequisites are completed within the required timeframe.

In an embodiment, the academic pathway is optimized to minimize time to completion, reduce cost, and balance personalized conditions such as geographic preferences and course delivery modes. Multi-institution scheduling is supported by coordinating academic terms and credit transfer policies. The optimized pathway is presented on a user interface, displaying a detailed timeline, interactive elements for customization, and notifications regarding registration deadlines and prerequisite completion requirements.

An embodiment of the present disclosure relates to the system for optimizing academic pathway for a user to achieve academic goals. The system includes a receiver module to receive user data associated with the user. The user data includes course completion data, academic goal data, and personalized conditions. The course completion data includes course identifiers, credit values, grade information, and/or current institute metadata. The academic goal data includes target degree, desired major, intended transfer institution, and career objectives. The personalized conditions include credit limits, geographic preferences, course availability constraints, preferred course delivery modes, and desired credit load per term.

In an embodiment, the system includes an extraction module to extract course metadata from the course completion data and academic goal data. The course metadata includes course descriptions, learning outcomes, and/or prerequisite dependencies.

In an embodiment, the system includes an analysis module to analyze the extracted course metadata to determine course requirements that the user has not yet fulfilled to achieve the academic goal. The analysis includes employing natural language processing (NLP) techniques to analyse the extracted course metadata. The NLP techniques include named entity recognition, dependency parsing, semantic analysis, and/or contextual embedding models.

In an embodiment, the system includes a mapping module to map each of the determined course requirements to equivalent courses across a plurality of educational institutions. The mappings are performed via utilizing NLP mapping, knowledge graphs for equivalency mapping, and credit structure matching.

In an embodiment, the system includes a sequencing module to sequence the equivalent courses associated with each of the determined course requirements in a logical order. The sequencing is performed by arranging the courses in the correct order to satisfy prerequisite dependencies and co-requisite requirements. Further, the sequencing is performed by balancing credit loads across academic terms to avoid overload or underload. Furthermore, the sequencing is performed by ensuring compliance with institutional scheduling constraints, including course availability and enrolment limits. Moreover, the sequencing is performed by generating a logically ordered pathway that satisfies all course requirements without violating any prerequisite dependencies.

In an embodiment, the sequencing of the equivalent courses is performed by applying rolling time window constraints, ensuring prerequisites are completed within the required academic timeframe.

In an embodiment, sequencing the equivalent courses in the logical order includes arranging the courses in the correct order to satisfy prerequisite dependencies and co-requisite requirements associated with each of the determined course requirements. Further, sequencing the equivalent courses in the logical order includes balancing credit loads across academic terms to avoid overload or underload while ensuring steady progress toward the academic goal. Furthermore, sequencing the equivalent courses in the logical order includes grouping related courses to maintain continuity in subject matter or specialization, thereby enhancing learning outcomes and knowledge retention. Moreover, sequencing the equivalent courses in the logical order includes aligning course sequences with institutional scheduling constraints, including course availability, enrolment limits, and/or term-specific offerings. Additionally, sequencing the equivalent courses in the logical order includes minimizing gaps between sequential courses that require foundational knowledge from prior courses, ensuring timely progression through prerequisite chains.

In an embodiment, the system includes an optimization module to optimize an academic pathway for the sequenced equivalent courses based on the received personalized conditions. The optimization is performed by minimizing time to completion by selecting the most efficient sequence of terms while maximizing credit transfer opportunities. Further, the optimization is performed by reducing cost of attendance by considering tuition fees, financial aid options, and travel expenses. Furthermore, the optimization is performed by adhering to personalized conditions received from the user, including geographic preferences, preferred course delivery modes, and desired credit load per term. Moreover, the optimization is performed by maximizing the overall efficiency of the pathway by balancing time, cost, credit transfer, and user preferences, thereby generating the most effective and feasible academic plan.

In an embodiment, optimization of the academic pathway includes considering cross-institutional credit transfers, scheduling conflicts, geographic preferences, course delivery modes, travel constraints, financial aid availability, scholarship opportunities, or tuition reimbursement policies relevant to the user.

In an embodiment, optimization of the academic pathway includes multi-institution scheduling. The multi-institution scheduling is performed by coordinating course schedules across the plurality of educational institutions to ensure that the sequenced equivalent courses can be completed without scheduling conflicts. Further, the multi-institution scheduling is performed by synchronizing academic terms by aligning start and end dates across the plurality of educational institutions. Furthermore, the multi-institution scheduling is performed by maximizing credit transfer by selecting course combinations that fulfil the determined course requirements while satisfying cross-institutional credit transfer policies. Moreover, the multi-institution scheduling is performed by minimizing travel requirements by prioritizing course selections that reduce commuting time when multiple institutions are involved.

In an embodiment, the system includes a rendering module to render the optimized pathway on a user device. The rendering includes displaying the cross-institutional course schedule with a detailed timeline showing the sequence of terms and corresponding courses. Further, the rendering includes providing interactive visual elements that allow the user to view prerequisites, co-requisites, credit values, and course delivery modes. Furthermore, the rendering includes enabling user customization by allowing the user to adjust course selections, credit loads, or preferred institutions directly through the interface. Moreover, the rendering includes generating a summary of progress toward the academic goal, including an overview of completed, in-progress, and upcoming courses required to achieve the goal. Additionally, the rendering includes generating customized notifications to the user regarding registration deadlines, course availability updates, and prerequisite completion requirements associated with the optimized academic pathway.

An embodiment of the present disclosure relates to a method for optimizing academic pathway for a user to achieve academic goals. The method includes receiving user data associated with the user. The user data includes course completion data, academic goal data, and personalized conditions. Further, the method includes extracting course metadata from the user data. The course metadata includes course descriptions, learning outcomes, and prerequisite dependencies. Furthermore, the method includes analyzing the extracted course metadata to determine course requirements that the user has not yet fulfilled to achieve the academic goal. Moreover, the method includes mapping each of the determined course requirements to equivalent courses across a plurality of educational institutions. Additionally, the method includes sequencing the equivalent courses associated with each of the determined course requirements in a logical order. In an embodiment, the method includes optimizing an academic pathway for the sequenced equivalent courses based on the received personalized conditions. Further, the method includes rendering the optimized pathway on a user device.

The features and advantages of the subject matter here will become more apparent in light of the following detailed description of selected embodiments, as illustrated in the accompanying FIGURES. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

The present subject matter will now be described in detail with reference to the drawings, which are provided as illustrative examples of the subject matter so as to enable those skilled in the art to practice the subject matter. Notably, the FIGURES and examples are not meant to limit the scope of the present subject matter to a single embodiment, but other embodiments are possible by way of interchange of some or all of the described or illustrated elements and, further, wherein:

FIG. 1 illustrates an exemplary environment having an academic pathway optimization system for optimizing academic pathway for a user to achieve academic goals, in accordance with an embodiment of the present disclosure;

FIG. 2 illustrates an exemplary block diagram of the system for optimizing academic pathway for a user to achieve academic goals, in accordance with an embodiment of the present disclosure;

FIGS. 3A-3C illustrate exemplary operations of the system for optimization of credit transfers across multiple institutions, in accordance with an embodiment of the present disclosure;

FIGS. 4A-4D illustrate exemplary AI-powered chatbot for evaluating graduation readiness and optimizing course planning, in accordance with an embodiment of the present disclosure;

FIG. 5A illustrates a sequence phase diagram outlining the chronological flow of operations involved in generating an optimized academic pathway, in accordance with an embodiment of the present disclosure;

FIG. 5B illustrates an overview of a credit matching logic flow for evaluating and identifying equivalent courses across academic institutions, in accordance with an embodiment of the present disclosure;

FIG. 5C illustrates an exemplary flow diagram for course metadata processing and optimized academic pathway generation, in accordance with an embodiment of the present disclosure;

FIG. 6 is a flowchart illustrating a method for optimizing academic pathway for a user to achieve academic goals, in accordance with an embodiment of the present disclosure;

FIG. 7 is an exemplary computer unit in which or with which embodiments of the present disclosure may be utilized.

Other features of embodiments of the present disclosure will be apparent from accompanying drawings and detailed description that follows.

### DETAILED DESCRIPTION

In the following description, for purposes of explanation, numerous specific details are set forth in order to provide a thorough understanding of the present disclosure. It will be apparent, however, to one skilled in the art that the present disclosure is not limited to these specific details. In other instances, structures and devices are shown in block diagram form only in order to avoid obscuring the present technology.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Embodiments of the present disclosure relate to a system and method for optimizing academic pathway for a user to achieve academic goals. User data, including course completion records, academic objectives, and personalized conditions, may be received. From the received course completion records and academic objectives, course-related information may be extracted, including descriptions, learning outcomes, and prerequisite dependencies. The extracted information may then be analyzed to determine outstanding course requirements using natural language processing techniques, such as named entity recognition and semantic analysis, ensuring accurate assessment of unmet academic needs.

In an embodiment, identified course requirements may be mapped to equivalent courses available across multiple educational institutions. The mapping process may utilize knowledge graphs, NLP-based equivalency mapping, and credit structure comparisons to ensure accurate alignment between courses. Once equivalent courses are identified, they may be arranged in a logical sequence to satisfy prerequisite dependencies, co-requisite requirements, and credit load balance across academic terms. The sequencing process may also ensure compliance with institutional scheduling constraints, such as course availability and enrolment limits. Additionally, rolling time window constraints may be applied to ensure prerequisites are completed within the required academic timeframe, preventing delays in progression.

In an embodiment, the academic pathway may be optimized by considering the received personalized conditions, including minimizing time to completion, reducing costs, and balancing personalized conditions such as geographic preferences and preferred course delivery modes. Multi-institution scheduling may be facilitated by coordinating academic terms, aligning course offerings, and ensuring adherence to credit transfer policies. The optimized academic plan may then be presented through an interactive display, offering a structured timeline, customization options, and real-time notifications regarding registration deadlines, course availability, and prerequisite fulfilment.

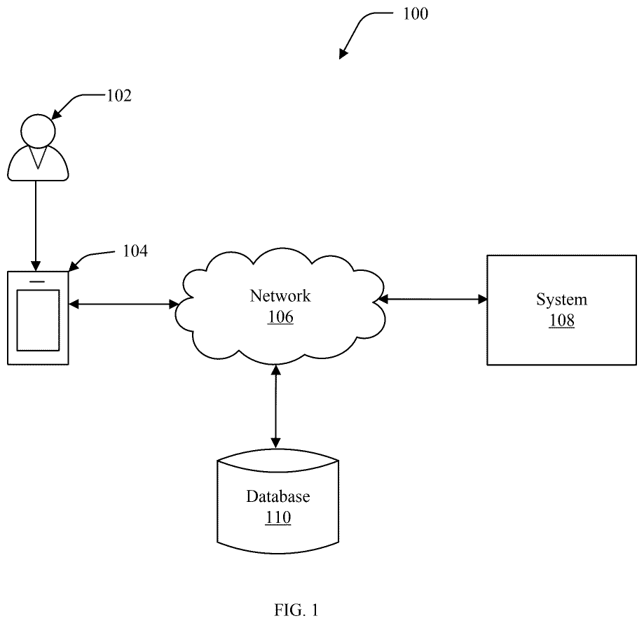

FIG. 1 illustrates an exemplary environment 100 having an academic pathway optimization system 108 for optimizing academic pathway for a user 102 to achieve academic goals, in accordance with an embodiment of the present disclosure.

In an embodiment, the environment 100 may include the user 102, a user device 104, communication network 106, the academic pathway optimization system 108, and a database 110. The user 102 may be a student, advisor, counsellor, or institutional stakeholder seeking to explore, customize, and optimize academic pathways tailored to specific educational objectives, such as earning a degree, changing majors, transferring to another institution, changing majors, and/or completing prerequisites for graduate school. Further, the user 102 may utilize the academic pathway optimization system 108 (here forth also termed as system 108) to explore potential academic pathways, understand course requirements, and make informed decisions about course selections, credit transfers, and scheduling. Additionally, the user 102 may seek guidance on minimizing the time to graduation, reducing costs, or aligning academic choices with career goals.

In an embodiment, the user 102 may interact with the system 108 via the user device 104. The user device 104 may include, but is not limited to, a computer, smartphone, tablet, or any other electronic gadget capable of connecting to the internet. Further, the user device 104 may facilitate accessing the system 108 functionalities, such as inputting academic goals, viewing recommended pathways, customizing course schedules, and receiving notifications.

In an embodiment, the communication network 106 may facilitate secure and efficient data transmission between the user device 104 and the system 108, ensuring real-time updates and seamless connectivity. The communication may include enabling data transmission over various communication channels, including the internet, Wi-Fi, cellular networks, or secure institutional networks. Further, the communication network 106 may support communication protocols such as HTTPS, WebSocket, or RESTful APIs, ensuring secure and real-time data exchange. Furthermore, the communication network 106 may implement end-to-end encryption to protect user data during transmission, ensuring compliance with educational data privacy regulations, such as FERPA or GDPR. Moreover, the communication network 106 may include authentication mechanisms, such as OAuth or multi-factor authentication (MFA), ensuring secure access to user accounts and personalized academic pathways.

In an embodiment, the system 108 may optimize academic pathways for the user 102 to achieve their educational goals. Further, the system 108 may receive user data, including course completion data, academic goal data, and personalized conditions and may dynamically generate, optimize, and adjust academic pathways based on individual needs. Furthermore, the system 108 may analyze course requirements, map them to equivalent courses across multiple institutions, sequence them in a logical order, and optimize the academic pathway while considering time, cost, and user preferences. Moreover, the system 108 may provide real-time recommendations, personalized academic plans, and interactive visualizations, facilitating the user 102 to make informed decisions about course selections, credit transfers, institute selections, and degree completion. Additionally, the system 108 may integrate with institutional APIs for real-time data updates, ensuring accuracy and relevance in academic pathway planning.

In an embodiment, the database 110 may store the user data, academic goal data, course metadata, institutional policies, and historical equivalency decisions required for academic pathway optimization. Further, the database 110 may include structured and unstructured data repositories, ensuring efficient storage, retrieval, and processing of diverse academic information. Furthermore, the database 110 may implement sharded database architecture with horizontal scaling capabilities, ensuring high availability and performance during peak usage. Moreover, the database 110 may support encrypted data storage and role-based access controls, ensuring data security and compliance with educational data privacy regulations.

In an embodiment, the database 110 may integrate with external data sources, such as public course catalogs, state-managed transfer equivalency platforms, or labor market intelligence platforms. Such integrations may facilitate comprehensive and up-to-date data availability for the system 108 recommendation accuracy and relevance. Further, the database 110 may support distributed data storage using cloud-native infrastructure, enabling scalable and resilient data management.

In an embodiment, the system 108 may be deployed as a cloud-based platform accessible via web and mobile applications. The deployment may support multi-user collaboration, enabling students, advisors, and institutional stakeholders to collaboratively review and adjust academic pathways in real time. In an embodiment, the system 108 may be integrated with learning management systems (LMS) or student information systems (SIS) through API integrations, enabling seamless data exchange and contextual recommendations. Such integration ensures that the user 102 receives accurate guidance based on their academic history, institutional policies, and evolving educational goals. In an embodiment, the system 108 may include offline functionalities, allowing the user 102 to plan and adjust academic pathways without continuous internet connectivity. The offline functionalities may be particularly useful for the user 102 in remote areas or those with limited access to reliable internet. Additionally, the system 108 may support personalized notifications, predictive alerts, and interactive simulations, ensuring an engaging and user-centric academic planning experience.

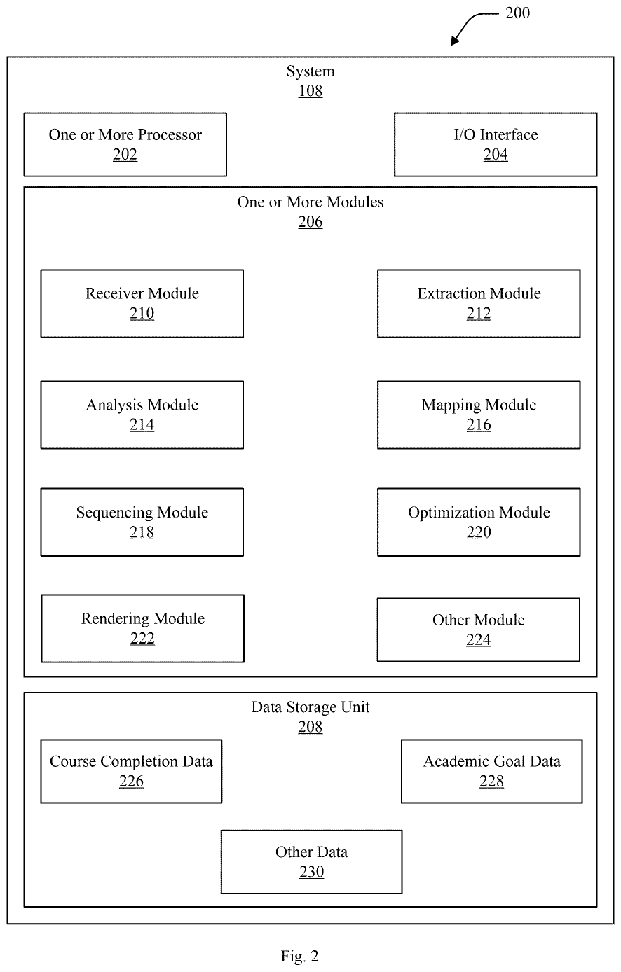

FIG. 2 illustrates an exemplary block diagram 200 of the system 108 for optimizing academic pathway for a user to achieve academic goals, in accordance with an embodiment of the present disclosure.

In an embodiment, the system 108 may include one or more processors 202, an In-put/Output (I/O) interface 204, one or more modules 206, and a data storage unit 208. The one or more processors 202 may be implemented as one or more microprocessors, microcomputers, digital signal processors, central processing units, state machines, logic circuitries, and/or any devices that manipulate signals based on operational instructions. Further, the I/O interface 204 may serve as the pivotal bridge connecting the internal processes of the system 108 with its external environment for facilitating the exchange of information between the system 108 and its users or external devices. Furthermore, the I/O interface 204 may contribute to the user experience by providing intuitive means for input, such as through keyboards or touchscreens, and presenting meaningful output via displays or other output devices. In an embodiment, the one or more modules 206 may include a receiver module 210, an extraction module 212, an analysis module 214, a mapping module 216, a sequencing module 218, an optimization module 220, a rendering module 222, and any other modules 224 essential or required for the working of the system 108. In an embodiment, the data storage unit 208 may include course completion data 226, academic goal data 228, and any other data 230 required for the working of the system 108. In an embodiment of the present disclosure, the one or more processors 202 and the data storage unit 208 may form a part of a chipset installed in the system 108. In another embodiment of the present disclosure, the data storage unit 208 may be implemented as a static memory or a dynamic memory. For example, the data storage unit 208 may be internal to the system 108, such as an onside-based storage. In another example, the data storage unit 208 may be external to the system 108, such as cloud-based storage. Further, the one or more module 206 may be communicatively coupled to the data storage unit 208 and the one or more processor 202 of the system 108. The one or more processors 202 may be configured to control the operations of the one or more modules 206.

In an embodiment, the receiver module 210 may receive user data associated with the user 102. The user data includes course completion data 226, academic goal data 228, and personalized conditions. The course completion data 226 includes course identifiers, credit values, grade information, and/or current institute metadata. The course identifiers may uniquely represent the courses completed by the user, enabling precise mapping and analysis. Credit values may indicate the number of credits earned for each course, which is essential for evaluating credit transfer and fulfilment of degree requirements. Grade information may provide details on the user's performance in each course, influencing eligibility for credit transfer or prerequisites. The current institute metadata may include information about the institution where the user completed the courses, such as institutional policies, course codes, and academic calendar details.

In an embodiment, the academic goal data 228 may include target degree, desired major, intended transfer institution, and career objectives. The target degree and desired major may specify the academic qualifications the user aims to achieve, guiding the system 108 pathway optimization. The intended transfer institution may indicate the user's preferred institution for credit transfer or degree completion, influencing the mapping and sequencing of courses. Career objectives may outline the user's long-term professional goals, enabling the system 108 to recommend courses that align with industry requirements or career pathways.

In an embodiment, the personalized conditions may include constraints such as credit limits, geographic preferences, course availability constraints, preferred course delivery modes (e.g., online or in-person), and desired credit load per term, ensuring that the academic pathway is customized to the user's lifestyle and preferences.

In an embodiment, the receiver module 210 may receive the information through one or more communication interfaces, which may include web-based forms, mobile applications, or integrated institutional databases. In an embodiment, the receiver module 210 may receive real-time updates or modifications to the user data. For instance, the user 102 may update their academic goals or add completed courses as they progress through their educational journey. The receiver module 210 may adjust the received data and seamlessly integrate these updates into the system 108. In an embodiment, the receiver module 210 may integrate with institutional APIs to automatically receive course completion data 226 and academic goal data 228 directly from the user 102 educational institution. The receiving may include receiving course details, credit values, and grade information through secure data exchange protocols, ensuring accuracy and real-time synchronization. In an embodiment, the receiver module 210 may support importing course completion data 226 from external systems, such as transcript upload features or third-party educational platforms. Optical Character Recognition (OCR) or Natural Language Processing (NLP) techniques may be utilized to parse and extract relevant information from uploaded documents, ensuring seamless integration of historical academic data. In an embodiment, the receiver module 210 may receive user preferences related to academic goals, such as preferred course pacing, learning styles, or scheduling constraints. Such preferences may further personalize the academic pathway, enhancing the user experience.

In an embodiment, the extraction module 212 may extract course metadata from the received course completion data and academic goal data. The course metadata may include course descriptions, learning outcomes, and/or prerequisite dependencies.

In an embodiment, the extraction module 212 may perform semantic parsing and entity recognition to accurately extract relevant information while maintaining contextual relationships. In an embodiment, the extraction module 212 may utilize advanced Natural Language Processing (NLP) techniques to process diverse formats of course descriptions. The processing may include performing text normalization, cleaning institution-specific formatting, and preserving semantic content to ensure accurate interpretation. Further, the extraction module 212 may identify and extract key components such as course objectives, topics covered, and assessment criteria, enabling detailed analysis and comparison of course content. Additionally, the extraction module 212 may implement domain-specific term standardization, mapping institution-specific academic terminology to a controlled vocabulary.

In an embodiment, the extraction module 212 may extract course metadata from the course completion data 226 and academic goal data 228. The extraction module 212 may analyze the course completion data 226 and academic goal data 228 to identify and extract relevant information required for accurate interpretation and understanding of academic content. The extracted course metadata may include detailed descriptions of course content, educational objectives, learning outcomes, credit structures, and prerequisite relationships.

In an embodiment, the extraction module 212 may implement a multi-stage extraction pipeline to standardize and structure the extracted course metadata. The initial stage may include text normalization and cleaning to remove institution-specific formatting, ensuring consistent data representation across diverse educational institutions. The formatting may include converting course descriptions from unstructured text into structured data formats, preserving semantic content while standardizing terminology for cross-institutional comparisons. In an embodiment, the extraction module 212 may include a structure extraction phase that identifies key components of course descriptions, such as course objectives, learning outcomes, and prerequisite dependencies. Such extraction may include recognizing and extracting prerequisite chains from both the course completion data 226 and academic goal data 228. Further, the structure extraction phase may identify co-requisite dependencies and course relationships, ensuring accurate extraction of interdependent course information.

In another embodiment, the extraction module 212 may employ natural language processing (NLP) techniques, including named entity recognition, dependency parsing, and contextual embedding models, to extract relevant course metadata. The NLP techniques may analyze the syntactic and semantic structure of course descriptions, identifying essential entities such as course titles, learning objectives, and prerequisite dependencies. Further, the extraction module 212 utilizes domain-specific vocabulary management to interpret institution-specific academic terminology accurately and map it to standardized terms, ensuring consistent interpretation and comparison of course metadata.

In an embodiment, the extraction module 212 may utilize a hierarchical knowledge graph representing courses, institutions, majors, and their interdependencies. The knowledge graph may be enriched with semantic annotations to infer implicit relationships between courses, such as prerequisite chains, co-requisite requirements, and equivalent courses across institutions. Further, the knowledge graph may facilitate the extraction module 212 to accurately identify prerequisite dependencies from both the course completion data 226 and academic goal data 228.

In an embodiment, the extraction module 212 may employ a domain-specific embedding generator to generate vector embeddings for course descriptions and learning outcomes. The embeddings may capture the semantic and contextual meaning of academic content, enabling accurate extraction and alignment of learning outcomes with course requirements. Further, the embeddings may be dynamically updated using self-supervised temporal objectives to reflect changes in academic offerings and institutional policies, ensuring accurate and relevant extraction of course metadata.

In an embodiment, the extraction module 212 may implement a multi-modal feature fusion approach to extract course metadata from diverse data sources, including course catalogs, syllabi, institutional websites, and public databases. Such extraction may include combining text-based features with structured data attributes, such as credit values, academic levels, and course identifiers, ensuring comprehensive extraction of relevant course metadata. Further, the extraction module 212 may extract contextual metadata, such as geographic preferences, delivery modes, and enrolment constraints, ensuring accurate extraction of personalized academic information.

In an embodiment, the extraction module 212 may implement a bi-directional extraction flow, where course metadata is extracted from the course completion data 226 and the academic goal data 228. The bi-directional flow ensures that the system 108 captures both the user 102 completed coursework and intended academic goals. For example, the extraction module 212 may extract prerequisite dependencies required for courses listed in the academic goal data 228, ensuring that all foundational knowledge is completed before advanced courses. Similarly, the extraction module 212 may extract learning outcomes from the course completion data 226 to assess alignment with the academic goals, ensuring accurate interpretation of completed coursework.

In an embodiment, the analysis module 214 may analyze the extracted course metadata to determine course requirements that the user 102 has not yet fulfilled to achieve the academic goal. The analysis may include employing natural language processing (NLP) techniques to analyse the extracted course metadata. The NLP techniques may include named entity recognition, dependency parsing, semantic analysis, and/or contextual embedding models.

In an embodiment, the analysis may include analysing the extracted course descriptions, learning outcomes, and prerequisite dependencies. Further, the analysis may ensure that the academic pathway is aligned with the user 102 educational objectives and institutional requirements.

In an embodiment, the analysis module 214 may compare the user 102 completed coursework against the requirements for the academic goal. The comparison may facilitate identifying gaps where required courses, credits, or competencies are missing. Further, the comparison may include evaluating prerequisite dependencies, core requirements, elective options, and institutional policies to determine the outstanding course requirements necessary for degree completion, major declaration, or transfer eligibility.

In an embodiment, the analysis module 214 may categorize the course requirements into different types, including mandatory core courses, major-specific requirements, electives, and prerequisite chains. The analysis module 214 may compare the user 102 completed courses with the categorized requirements to identify missing components. For example, if the academic goal includes a specific major, the analysis module 214 may identify major-specific courses that the user has not yet completed. If the academic goal involves transferring to a different institution, analysis module 214 may identify courses required for transfer eligibility based on articulation agreements or institutional transfer policies.

In another embodiment, the analysis module 214 may utilize natural language processing (NLP) techniques to analyze the extracted course metadata and determine the unmet course requirements. Named entity recognition (NER) may be used to identify required courses, prerequisites, and co-requisites by recognizing relevant academic entities within course descriptions. Dependency parsing may analyze the syntactic structure of course descriptions to identify prerequisite chains and co-requisite dependencies, ensuring accurate determination of required foundational knowledge. Semantic analysis may interpret learning outcomes to determine if the user's completed courses satisfy the required competencies for the academic goal. Contextual embedding models may be employed to compare learning outcomes between the user's completed courses and the required courses, ensuring accurate alignment and gap identification.

In an embodiment, the analysis module 214 may employ a knowledge graph representing academic requirements as interconnected nodes and edges. The knowledge graph may include nodes for courses, prerequisites, co-requisites, learning outcomes, and degree requirements. The analysis module 214 may traverse the graph to identify unmet requirements by checking for nodes that are not satisfied by the user's completed coursework. Further, the graph-based approach ensures accurate determination of unmet course requirements, including complex prerequisite chains and co-requisite relationships. In an embodiment, the analysis module 214 may implement a rule-based reasoning engine that applies institutional policies and accreditation standards to determine unmet course requirements. The rule-based engine may evaluate the user's completed coursework against predefined rules for credit transfers, degree requirements, and elective categories. The rule based transfer may ensure compliance with institutional regulations and accurate identification of missing requirements. In an embodiment, the analysis module 214 may integrate with external data sources, such as institutional APIs or public academic databases, to validate the determined course requirements against official degree requirements or transfer eligibility criteria. The integration may ensure that the analysis remains accurate and up-to-date with institutional policy changes, including new course offerings, curriculum updates, or changes in transfer articulation agreements.

In an embodiment, the mapping module 216 may map each of the determined course requirements to equivalent courses across a plurality of educational institutions. The mappings may be performed via utilizing Natural Language Processing (NLP) mapping, knowledge graphs for equivalency mapping, and credit structure matching.

In an embodiment, the NLP mapping techniques interpret course descriptions, learning outcomes, and prerequisite dependencies. NLP mapping may include semantic similarity analysis, contextual embedding models, and domain-specific vocabulary management to accurately map course requirements to equivalent courses. The named entity recognition may facilitate identifying key academic entities, dependency parsing to understand the syntactic relationships within course descriptions, and semantic analysis to capture contextual meaning. Additionally, contextual embedding models may be used to understand the academic terminology within the context of institutional policies, ensuring accurate and consistent mappings.

In an embodiment, the knowledge graphs may represent academic relationships, including course prerequisites, co-requisites, transfer equivalencies, and degree pathways, as directed, labelled edges within a hierarchical structure. The representation may include representing courses, majors, and institutions as nodes and the academic relationships between them as edges. The knowledge graph may be enriched with semantic annotations, enabling the system 108 to infer implicit relationships, such as recognizing that two courses with overlapping descriptions may be equivalent. The hierarchical layers may include an institutional layer, an academic program layer, and a course layer, ensuring comprehensive modeling of complex academic relationships. Further, the knowledge graph may support cross-institutional equivalency mapping by maintaining mappings between local institutional vocabularies and standardized terminology.

In an embodiment, the mapping module 216 may also perform credit structure matching to ensure that the mapped equivalent courses align with the user 102 credit requirements. Credit structure matching may include analyzing course credit values, contact hours, and assessment criteria to evaluate equivalency. Further, the mapping module 216 may include harmonizing diverse credit hour systems while maintaining compliance with accreditation requirements. The mapping module 216 may implement configurable rules for credit system conversion and utilize validation components to ensure accurate credit transfers while supporting institutional policies.

In an embodiment, the mapping module 216 may implement graph-based optimization techniques for equivalency mapping. The mapping may include representing transfer pathways as directed graphs where nodes represent courses, majors, and institutions, and edges represent transfer equivalencies, prerequisites, or degree requirements. A multi-objective shortest-path algorithm may be used to identify the optimal pathway, minimizing the total number of credits required after transfer and maximizing the utilization of previously earned credits. Such graph-based approach may ensure efficient mapping of course requirements to equivalent courses across multiple institutions.

In an embodiment, the sequencing module 218 may sequence the equivalent courses associated with each of the determined course requirements in a logical order. The sequencing may be performed by arranging the courses in the correct order to satisfy prerequisite dependencies and co-requisite requirements. Further, the sequencing may be performed by balancing credit loads across academic terms to avoid overload or underload. Furthermore, the sequencing may be performed by ensuring compliance with institutional scheduling constraints, including course availability and enrolment limits. Moreover, the sequencing may be performed by generating the logically ordered pathway that satisfies all course requirements without violating any prerequisite dependencies.

In an embodiment, sequencing the equivalent courses in the logical order may include arranging the courses in the correct order to satisfy prerequisite dependencies and co-requisite requirements associated with each of the determined course requirements. Further, sequencing the equivalent courses in the logical order may include balancing credit loads across academic terms to avoid overload or underload while ensuring steady progress toward the academic goal. Furthermore, sequencing the equivalent courses in the logical order may include grouping related courses to maintain continuity in subject matter or specialization, thereby enhancing learning outcomes and knowledge retention. Moreover, sequencing the equivalent courses in the logical order may include aligning course sequences with institutional scheduling constraints, including course availability, enrolment limits, and/or term-specific offerings. Additionally, sequencing the equivalent courses in the logical order may include minimizing gaps between sequential courses that require foundational knowledge from prior courses, ensuring timely progression through prerequisite chains.

In an embodiment, the sequencing module 218 may arrange the courses in the correct order to satisfy prerequisite dependencies and co-requisite requirements, ensuring compliance with the hierarchical progression of knowledge and institutional policies. For example, if a course requires completion of foundational prerequisites, the sequencing module 218 may arrange the prerequisite courses in earlier academic terms before the advanced course is scheduled. The sequencing module 218 may ensure that co-requisite courses are scheduled within the same academic term to satisfy institutional enrolment policies.

In an embodiment, the sequencing module 218 may balance credit loads across academic terms to avoid overload or underload. The balancing of credit loads may include distributing courses evenly across semesters to maintain a manageable workload while ensuring steady progress toward the academic goal. Further, the sequencing module 218 may consider institutional policies, such as minimum and maximum credit requirements per term, to optimize the credit load distribution. For example, the sequencing module 218 may balance credit loads by scheduling a mix of core courses and electives within each term, ensuring that the user 102 does not exceed credit limits or face an unbalanced academic workload.

In an embodiment, the sequencing module 218 may ensure compliance with institutional scheduling constraints, including course availability and enrolment limits. The compliance may include scheduling courses based on historical course availability patterns, such as courses offered only in specific semesters or academic years. The sequencing module 218 may account for enrolment constraints by ensuring that high-demand courses are prioritized in the user 102 schedule to secure a spot. Further, the sequencing module 218 may utilize course availability prediction models to forecast future offerings and align the user's academic pathway accordingly.

In an embodiment, the sequencing module 218 may generate the logically ordered pathway that satisfies all course requirements without violating any prerequisite dependencies. The logically ordered pathway generation may include arranging courses in a coherent sequence that aligns with the logical progression of knowledge. For example, introductory courses may be scheduled before advanced electives or capstone projects, ensuring that the user acquires the necessary foundational knowledge before pursuing specialized coursework. Further, the sequencing module 218 may align the course sequence with degree requirements, ensuring that mandatory courses are completed within the required timeframe while fulfilling all prerequisite dependencies.

In an embodiment, the sequencing module 218 may employ a temporal logic system to model prerequisite dependencies, co-requisites, and graduation requirements as temporal relationships. The temporal logic system may ensure that courses are scheduled in the correct chronological order to satisfy all academic constraints. Further, the sequencing module 218 may also support rolling time window constraints, ensuring that prerequisite chains are completed within the required academic timeframe. For example, the temporal logic system may enforce constraints such as completing at least two core courses every two semesters to maintain steady progress toward graduation.

In an embodiment, the sequencing of the equivalent courses may be performed by applying rolling time window constraints, ensuring prerequisites are completed within the required academic timeframe. The sequencing module 218 may dynamically adjust the course sequence across multiple semesters to maintain logical progression while satisfying prerequisite dependencies and co-requisite requirements. The adjustment may include continuously evaluating prerequisite completion status and adjusting future course schedules to accommodate changes in academic performance, course availability, or institutional policies.

In an embodiment, the sequencing module 218 may apply rolling time window constraints to maintain temporal consistency across multiple academic terms. The rolling time window application may include enforcing constraints such as completing a minimum number of core courses within a specific time window or ensuring that prerequisite chains are completed within the required academic timeframe. For example, the sequencing module 218 may enforce a constraint that at least two core courses must be completed every two semesters to maintain steady progress toward the academic goal. If a prerequisite is not completed within the defined time window, the sequencing module 218 may adjust the course sequence to reschedule de-pendent courses in future terms.

In an embodiment, the sequencing may include evaluating hierarchical prerequisite chains to ensure that foundational courses are completed before advanced courses. For example, the sequencing module 218 may schedule introductory courses before specialized electives, ensuring that the user acquires the necessary foundational knowledge before progressing to advanced coursework. Similarly, the sequencing module 218 may schedule co-requisite courses in the same academic term to comply with institutional policies. In an embodiment, the sequencing module 218 may balance credit loads across academic terms to avoid overload or underload while ensuring steady progress toward the academic goal. Further, the sequencing module 218 may include distributing courses evenly across semesters, maintaining a manageable workload for the user. Furthermore, the sequencing module 218 may consider institutional policies, including minimum and maximum credit requirements per term, to optimize the credit load distribution. For example, the sequencing module 218 may balance credit loads by scheduling a combination of core courses and electives, ensuring the user does not exceed credit limits while maintaining consistent academic progress.

In an embodiment, the sequencing module 218 may group related courses to maintain continuity in subject matter or specialization, thereby enhancing learning outcomes and knowledge retention. The sequencing may include clustering courses with overlapping content or related academic disciplines, ensuring a logical progression of knowledge. For example, the module may group a series of mathematics courses or science electives, maintaining subject continuity and supporting cumulative learning. Such grouping strategy may also minimize cognitive load by allowing the user 102 to focus on a cohesive area of study within each academic term.

In an embodiment, the sequencing module 218 may align course sequences with institutional scheduling constraints, including course availability, enrolment limits, and term-specific offerings. The course sequence alignment may include scheduling courses based on historical availability patterns, such as courses offered only in specific semesters or academic years. The sequencing module 218 may also account for enrolment constraints by prioritizing high-demand courses in the user 102 schedule to secure enrolment. For example, the sequencing module 218 may prioritize required courses with limited capacity, ensuring timely progression through mandatory requirements while avoiding scheduling conflicts.

In an embodiment, the sequencing module 218 may minimize gaps between sequential courses that require foundational knowledge from prior courses, ensuring timely progression through prerequisite chains. Such sequencing may include analyzing prerequisite dependencies to identify sequential courses that require continuous knowledge progression. For example, the sequencing module 218 may schedule sequential mathematics or language courses in consecutive semesters to maintain knowledge retention. Additionally, the sequencing module 218 may minimize gaps between co-requisite courses, ensuring simultaneous enrolment to satisfy institutional policies.

In an embodiment, the optimization module 220 may optimize an academic pathway for the sequenced equivalent courses based on the received personalized conditions. The optimization may be performed by minimizing time to completion by selecting the most efficient sequence of terms while maximizing credit transfer opportunities. Further, the optimization may be performed by reducing cost of attendance by considering tuition fees, financial aid options, and travel expenses. Furthermore, the optimization may be performed by adhering to personalized conditions received from the user 102. The personalized conditions may include credit limits, geographic preferences, course availability constraints, preferred course delivery modes, and desired credit load per term. Moreover, the optimization may be performed by maximizing the overall efficiency of the pathway by balancing time, cost, credit transfer, and user preferences, thereby generating the most effective and feasible academic plan.

In an embodiment, the optimization module 220 may generate optimized academic pathway that is both efficient and adaptable to the user 102 specific constraints and preferences. The optimized pathway may include considering credit limits to ensure that the total enrolled credits per term do not exceed or fall below the user's specified constraints. Geographic preferences may be factored in to prioritize course selections at institutions within a preferred location or commuting range. Course availability constraints may be analyzed to align the academic pathway with institutional scheduling, ensuring that required courses are taken in available terms without conflicts. Additionally, preferred course delivery modes, such as in-person, online, or hybrid formats, may be incorporated to match the user 102 learning preferences. Furthermore, desired credit load per term may be optimized to balance academic workload, ensuring steady progress without exceeding personal capacity.

In an embodiment, optimization of the academic pathway may include considering cross-institutional credit transfers, scheduling conflicts, geographic preferences, course delivery modes, travel constraints, financial aid availability, scholarship opportunities, or tuition reimbursement policies relevant to the user 102.

In an embodiment, optimization of the academic pathway may include multi-institution scheduling. The multi-institution scheduling may be performed by coordinating course schedules across the plurality of educational institutions to ensure that the sequenced equivalent courses may be completed without scheduling conflicts. Further, the multi-institution scheduling may be performed by synchronizing academic terms by aligning start and end dates across the plurality of educational institutions. Furthermore, the multi-institution scheduling may be performed by maximizing credit transfer by selecting course combinations that fulfil the determined course requirements while satisfying cross-institutional credit transfer policies. Moreover, the multi-institution scheduling may be performed by minimizing travel requirements by prioritizing course selections that reduce commuting time when multiple institutions are involved.

In an embodiment, an optimization module 220 may optimize an academic pathway for the sequenced one or more equivalent courses. The optimization may be performed to minimize time to completion by selecting the most efficient sequence of terms while maximizing credit transfer opportunities. The optimization may include analyzing the user 102 previously completed courses and determining the optimal combination of equivalent courses that satisfy the determined course requirements. The optimization module 220 may employ predictive outcome modeling to estimate the likelihood of successful credit transfer and degree completion based on historical data, ensuring that the academic pathway is both efficient and feasible.

In an embodiment, the optimization module 220 may reduce the cost of attendance by considering tuition fees, financial aid options, and travel expenses associated with attending multiple institutions. The optimization may include performing a cost-benefit analysis of different course combinations and selecting the least expensive option while maintaining academic progress. Further, the optimization module 220 module may consider personalized financial conditions, such as scholarship eligibility or tuition reimbursement policies relevant to the user 102, ensuring that the optimized pathway aligns with the user 102 financial constraints.

In another embodiment, the optimization module 220 may maximize the overall efficiency of the pathway by balancing time, cost, credit transfer, and user preferences, thereby generating the most effective and feasible academic plan. The efficiency maximization may include optimizing credit load per term to maintain a balanced workload while avoiding overload or underload. Further, the optimization module 220 may implement specialized fitness functions incorporating academic success metrics, such as maintaining a manageable workload and avoiding course overlaps, to ensure that the user 102 academic performance is optimized while adhering to institutional constraints.

In an embodiment, the optimization module 220 may include multi-institution scheduling to optimize cross-institutional pathways. The scheduling may include coordinating course schedules across a plurality of educational institutions to ensure that the sequenced one or more equivalent courses can be completed without scheduling conflicts. Further, the optimization module 220 may synchronize academic terms by aligning start and end dates across the educational institutions involved in the optimized pathway, ensuring a seamless transition between institutions. Furthermore, the optimization module 220 may maximize credit transfer by selecting course combinations that fulfil the determined course requirements while satisfying cross-institutional credit transfer policies.

In an embodiment, the optimization module 220 may facilitate maximum utilization of credits across multiple institutions, minimizing redundancy and time-to-graduation. Further, the optimization module 220 may include allocating credits to degree requirements based on institutional constraints, such as residency requirements or maximum allowable transfer credits. Furthermore, the optimization module 220 may ensure that prerequisites are fulfilled before advanced courses are scheduled, maintaining academic progression. Moreover, the optimization module 220 may iteratively adjust credit assignments to resolve conflicts when the same course satisfies multiple requirements, ensuring accurate credit reconciliation. In an embodiment, the optimization module 220 may dynamically adjust the academic pathway based on real-time changes in institutional policies, course availability, or student performance.

In an embodiment, the optimization module 220 may employ a Constraint Propagation Algorithm (CPA) for academic contexts to generate feasible and efficient course schedules. The algorithm may enforce domain-specific constraints, such as prerequisites, co-requisites, credit limits, and institutional policies, ensuring that academic requirements are satisfied. For-ward constraint propagation may ensure that prerequisite courses are scheduled before dependent courses, while backward constraint propagation may analyze graduation requirements and identify missing courses that need to be scheduled earlier. For example, if a course C requires prerequisite P, the system 108 may enforce the constraint that Completion(P)<Enrolment(C), ensuring correct sequencing. Additionally, the system 108 may implement dynamic constraint updates, adapting to real-time institutional changes, such as course availability modifications or user-driven adjustments, ensuring that the generated schedule remains valid and optimized across multiple iterations of the optimization process.

In another embodiment, the optimization module 220 may integrate a Hybridized Optimization Approach, combining multiple algorithms, heuristics, and specialized fitness functions to enhance scalability and efficiency. The system 108 may employ custom genetic algorithms designed for academic scheduling, where each potential schedule is represented as a chromosome, with individual genes representing courses characterized by semester allocation, credit value, and availability. Novel crossover and mutation techniques may be applied to exchange course blocks that satisfy prerequisites and introduce variations, ensuring diversity in scheduling solutions. Additionally, heuristics for academic pathway optimization may be employed, including time-to-graduation minimization, which prioritizes schedules that reduce the number of semesters required for degree completion. A cluster-based course assignment method may group interdependent courses into clusters and assign them to semesters using depth-first search, ensuring that high-priority courses are scheduled early.

In an embodiment, the optimization module 220 may evaluate schedules using specialized fitness functions that incorporate academic success metrics. A completion score may measure how well a schedule meets graduation requirements, while credit load balancing ensures that course loads are evenly distributed across semesters, preventing overload or underload. The system 108 may integrate predictive academic success metrics, such as GPA impact and availability scores, to optimize schedules based on historical performance data, ensuring students maintain a manageable workload while progressing efficiently toward their academic goals. Such combined optimization techniques may ensure that academic pathways are dynamically adjusted, efficient, and aligned with institutional policies and user preferences.

In an embodiment, the rendering module 222 may render the optimized pathway on the user device 104. The rendering may include displaying the cross-institutional course schedule with a detailed timeline showing the sequence of terms and corresponding courses. The timeline may provide a visual representation of the user 102 academic journey, allowing the user to understand the chronological order of the courses required to achieve the academic goal. Further, the rendering may provide interactive visual elements that facilitate the user 102 to view prerequisites, co-requisites, credit values, and course delivery modes. Furthermore, the rendering may include facilitating user customization by allowing the user 102 to adjust course selections, credit loads, or preferred institutions directly through the interface. Moreover, the rendering may include generating a summary of progress toward the academic goal, including an overview of completed, in-progress, and upcoming courses required to achieve the goal. Additionally, the rendering may include generating customized notifications to the user 102 regarding registration deadlines, course availability updates, and prerequisite completion requirements associated with the optimized academic pathway.

In an embodiment, the rendering module 222 may provide interactive nodes, representing individual courses and edges indicating prerequisite or co-requisite dependencies. The users 102 may interact with the nodes to view detailed course descriptions, learning outcomes, and credit values, enhancing their understanding of the academic pathway. Further, the rendering module 222 may provide color-coded indicators to distinguish between completed, in-progress, and planned courses, enabling the user 102 to track their academic progress visually. In embodiment, the rendering module 222 may enable user customization by allowing the user 102 to adjust course selections, credit loads, or preferred institutions directly through the interface. Further, the rendering module 222 may display the updated schedule, providing real-time feedback on potential conflicts or impacts on graduation timelines. Additionally, the rendering module 222 may support constraint editing, enabling users 102 to modify maximum credit loads, preferred time slots, or geographic preferences, ensuring the optimized pathway aligns with the user 102 lifestyle and preferences.

In the embodiment, the rendering module 222 may generate a summary of progress toward the academic goal, including an overview of completed, in-progress, and upcoming courses required to achieve the goal. Further, the rendering module 222 may include generating semantic summaries that contextualize the academic pathway, such as explaining how completed courses satisfy degree requirements or how planned courses contribute to the user 102 career objectives. The rendering module 222 may provide contextual notifications, highlighting prerequisite dependencies or alerting users to potential scheduling conflicts.

In an embodiment, the rendering module 222 may generate customized notifications to the user 102 regarding registration deadlines, course availability updates, and prerequisite completion requirements associated with the optimized academic pathway. Further, the rendering module 222 may include integrating with institutional APIs to receive real-time updates on course availability or enrolment limits, ensuring users are notified of critical deadlines. Furthermore, the rendering module 222 may provide predictive alerts, such as warnings about potential delays in graduation if prerequisites are not completed on time.

In an embodiment, the other modules 224 may enhance the functionality and performance of the system 108 for optimizing academic pathways. The other module 224 may be essential or required for the effective working of the system 108 and may provide supplementary capabilities that support the primary modules. In an embodiment, the other modules 224 may include a simulation module to simulate the impact of specific academic decisions on the user's pathway. The simulation module may allow users to visualize potential outcomes, such as changes in time to graduation, credit load distribution, and cost of attendance, resulting from course selections, sequencing adjustments, or changes in academic goals. Further, the simulation module may include scenario storage and management capabilities, allowing the user 102 to create, store, and retrieve multiple planning scenarios. Each scenario may represent a unique combination of academic choices, including course selections, transfer pathways, and credit loads. The scenarios may be stored as hierarchical graphs, with nodes representing courses, majors, or institutions, and edges representing dependencies or equivalences, such as prerequisites or credit transfers.

In an embodiment, the simulation module may track changes made to scenarios, facilitating the user 102 to compare different iterations and revert modifications. The tracked changes may allow users to explore various academic pathways without committing to a specific choice, ensuring flexibility in decision-making. In another embodiment, the simulation module may support pathway simulation by simulating the impact of specific academic decisions, such as changing a major, taking a gap semester, or transferring to a different institution. The simulation module may provide real-time visualizations of how these decisions affect the user 102 academic timeline, cost of attendance, and career trajectory. The simulation module may employ predictive outcome modeling to estimate the likelihood of successful degree completion, ensuring that users can make informed decisions.

In an embodiment, the simulation module may provide predictive insights for informed decision-making, ensuring optimized pathways that align with educational and career objectives. The simulation module may simulate time-to-graduation scenarios by projecting timelines based on selected courses and sequencing, dynamically adjusting for changes such as course additions, major changes, or credit load modifications. Further, the simulation module may explore credit transfer scenarios, evaluating cross-institutional credit equivalencies and residency requirements to estimate credit acceptance and contribution toward degree requirements. Furthermore, the simulation module may simulate cost scenarios by projecting attendance costs, including tuition, fees, travel expenses, and financial aid options, and explore cost-optimization strategies. Moreover, the simulation module may simulate career impact scenarios by mapping learning outcomes to industry requirements and providing career readiness scores, ensuring that academic choices align with career objectives and evolving career trends.

In an embodiment, the other modules 224 may include a data validation module to ensure the accuracy and integrity of received user data, an authentication module to provide secure user access and data privacy, and an update management module to synchronize institutional policies and course offerings. Further, the other module 224 may include a feedback integration module to capture user interactions and adapt recommendations dynamically, ensuring personalized and relevant academic pathways. Furthermore, the other modules 224 may collectively ensure comprehensive functionality, security, and adaptability of the system 108.

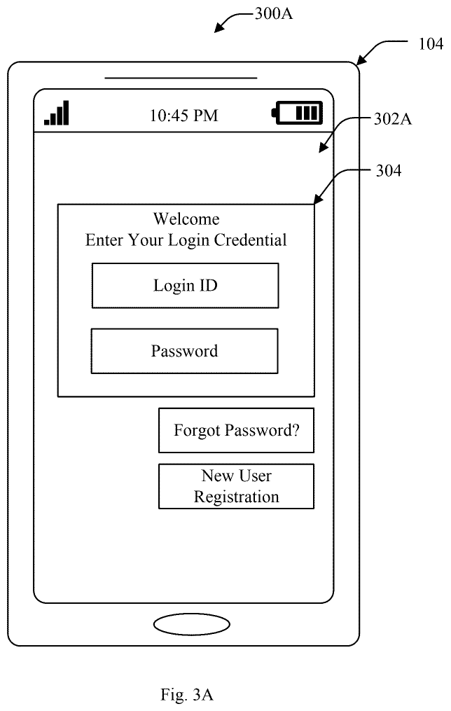

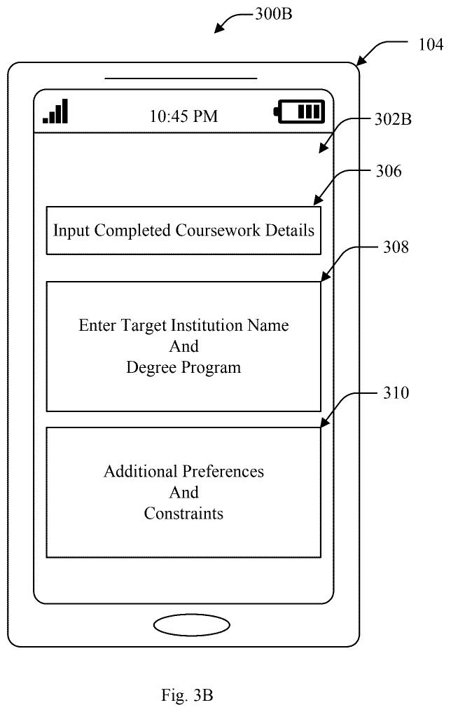

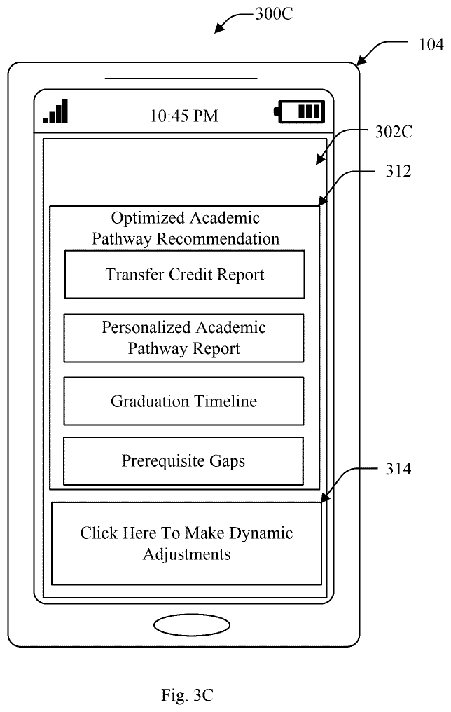

FIGS. 3A-3C illustrate exemplary operations 300A, 300B, and 300C of the system 108 for optimization of credit transfers across multiple institutions, in accordance with an embodiment of the present disclosure.

In an embodiment, the system 108 may facilitate the user 102 to streamline the transfer process and optimize the academic pathway. The user 102 may access the system 108 through the user device 104, as shown in FIG. 3A. User interface 302A may present prompts for the user 102 to enter login credentials 304, including a user login ID and password. The system 108 may also facilitate new user(s) to register. Once authenticated, the system 108 may grant access to the transfer credit optimization functionality.

As shown in FIG. 3B, user interface 302B may provide input fields for the user 102 to provide essential data for evaluation. The user 102 may input completed coursework 306, including details of courses taken at previous institutions, credit values, and grades. Further, the user 102 may specify the target institution and/or degree program 308, defining the intended academic goal. Further, the user 102 may provide additional preferences and constraints 310, such as minimizing redundant coursework, balancing credit load per semester, or prioritizing cost-efficient course options.

Upon receiving the user 102 input, the system 108 may initiate a structured process to evaluate transfer credits and generate an optimized academic pathway. Further, the system 108 may perform course equivalency matching by analyzing the user 102 completed coursework using Hierarchical Knowledge Graph (HKG). The HKG structured academic model may facilitate the system 108 to identify direct equivalencies between courses taken at previous institutions and those required at the target institution. For courses that do not have direct articulation agreements, the system 108 may apply similarity-based matching, ensuring alignment with program requirements at the receiving institution. Further, the system 108 may detect gaps in prerequisite fulfilment, flagging missing courses that the user 102 must complete before enrolling in advanced subjects within the target program.

Following the equivalency evaluation, the system 108 may proceed to optimal pathway generation, where a graph-based optimization algorithm may construct an academic pathway that prioritizes essential courses at the target institution while maximizing the use of transfer credits. The system 108 may recommend completing specific courses at the target institution while fulfilling remaining elective requirements at an alternate institution, ensuring efficient credit utilization. To further refine the pathway, the system 108 may apply multi-objective optimization, balancing key factors such as time-to-graduation, cost efficiency, and institutional transfer policies. Such optimization may ensure that the user 102 may progress toward their academic goal in the most efficient manner while minimizing redundant coursework and adhering to institutional requirements.

In an embodiment, the system 108 may present the analysis results via user interface 302C, displaying the optimized academic pathway recommendation 312, as shown in FIG. 3C. The optimized academic pathway recommendation 312 may include a detailed transfer credit report, listing courses accepted by the target institution, along with any outstanding requirements. Further, the optimized academic pathway recommendation 312 may generate a personalized academic pathway, suggesting a structured course sequence that optimizes credit utilization while aligning with institutional policies. In an embodiment, the system 108 may provide a time-to-graduation estimate, ensuring the user 102 can assess whether the pathway meets their intended completion timeline. Further, the optimized academic pathway recommendation 312 may high-light potential scheduling conflicts or prerequisite gaps, enabling the user 102 to proactively address any issues.

In an embodiment, the system 108 may provide interactive controls, presenting options for dynamic adjustment 314. The user 102 may explore alternative course sequences, modify constraints such as credit load per semester, or adapt to institutional changes, such as course availability updates. The system 108 may dynamically recalculates the academic pathway in response to such modifications, ensuring that the user 102 maintains an optimized and feasible route to graduation. By providing a structured, interactive, and adaptable transfer credit evaluation process, the system 108 may facilitate the user 102 to make informed decisions and achieve their educational goals with minimal redundancy and maximum credit utilization.

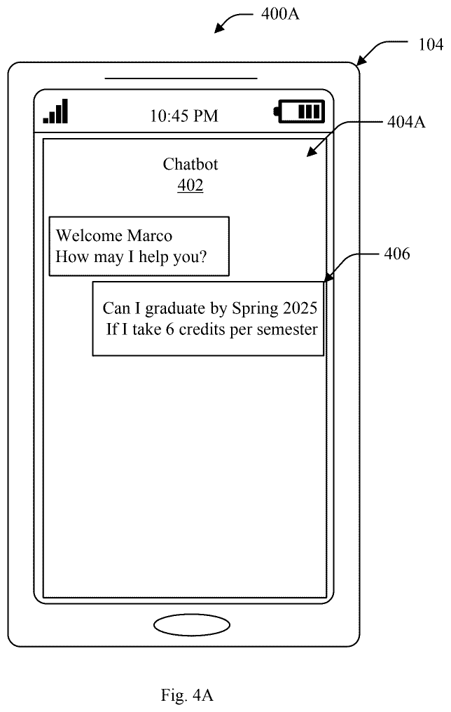

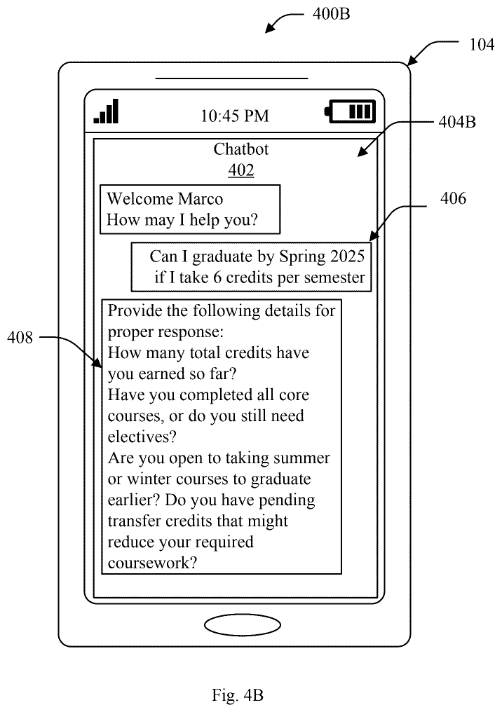

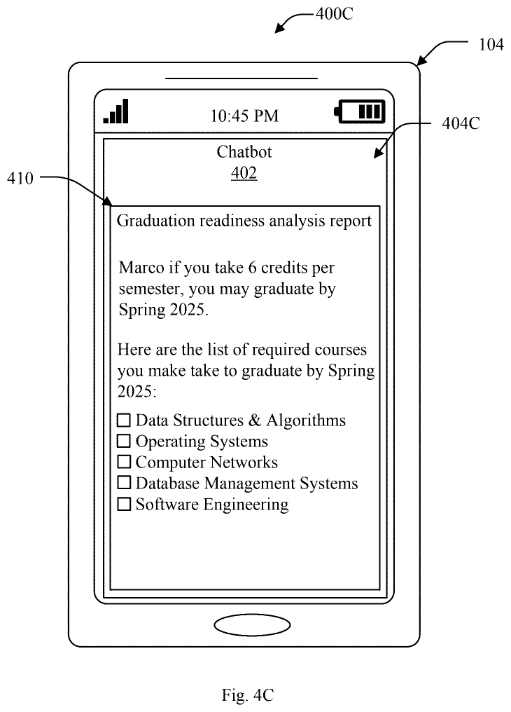

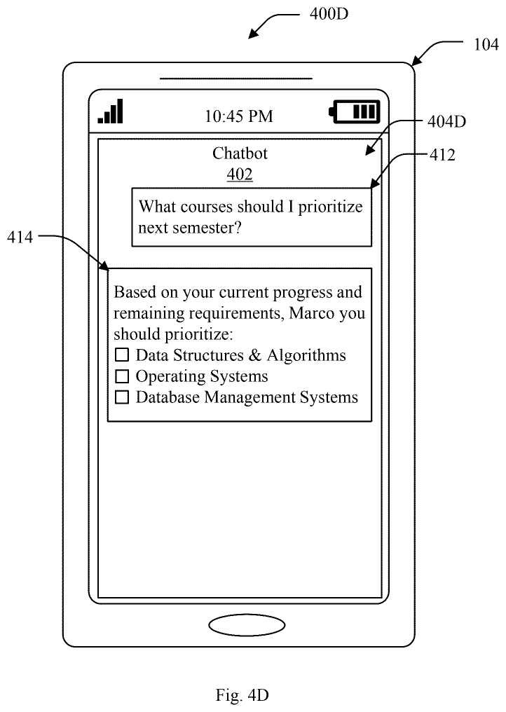

FIGS. 4A-4D illustrate exemplary AI-powered chatbot 402 for evaluating graduation readiness and optimizing course planning, in accordance with an embodiment of the present disclosure. In an embodiment, the user 102 (Marco) may access the chatbot 402 via user interface 404A, as shown in FIG. 4A. The chatbot 402 may be coupled to the academic pathway optimization system 108. Further, the chatbot 402 may leverage Natural Language Processing (NLP) and a Hierarchical Knowledge Graph (HKG) to analyze the user 102 queries and provide personalized academic guidance. Furthermore, the chatbot 402 may dynamically refine responses based on user input, ensuring accurate and adaptive academic planning.

In an embodiment, the user 102 may ask real-time academic planning questions related to credit load, graduation timeline, and course selection. For example, Marco may input a query such as, “Can I graduate by Spring 2025 if I take 6 credits per semester?”, as shown via 406. If the chatbot 402 has access to Marco's academic data, including completed coursework, remaining degree requirements, and institutional policies, the system 108 may analyze the information and provide an estimated graduation timeline. Further, the system 108 may also factor in prerequisite chains and institutional scheduling constraints to determine if Marco's goal is feasible at his current pace.

In an embodiment, if the chatbot 402 lacks sufficient data to properly provide an appropriate response, the chatbot 402 may prompt Marco for additional details, as shown through user interface 404B, requesting information, such as “How many total credits have you earned so far?”, “Have you completed all core courses, or do you still need electives?”, “Are you open to taking summer or winter courses to graduate earlier?”, “Do you have pending transfer credits that might reduce your required coursework?” etc., as shown via 408. Once Marco provides the necessary details, the chatbot may refine its response and present the graduation readiness analysis report 410 via user interface 404C. The response may include a projected graduation timeline, confirming if Marco can graduate by Spring 2025, a list of required courses, adaptive scheduling recommendations, and alternative pathways, such as increasing credit load or enrolling in specific electives that satisfy multiple requirements.

In an embodiment, a list of required courses may identify missing credits and prerequisites. Adaptive scheduling recommendations include suggesting an optimal semester-wise course load that balances Marco's part-time availability.

Additionally, Marco may query the chatbot 402 with, “What courses should I prioritize next semester?”, as shown by 412. The system 108 may analyze degree requirements and institutional scheduling data to recommend high-priority courses, as shown by 414, ensuring steady academic progress while optimizing for workload balance. If Marco wishes to modify his academic plan, user interface 402D may provide dynamic adjustment options. The adjustment options may include increasing or decreasing the credit load per semester to accommodate the user's academic pace and external commitments. Further, the adjustment options may facilitate the user 102 to explore alternative course sequences that align with institutional policies, ensuring compliance with prerequisite structures, course availability, and degree completion requirements. Furthermore, the adjustment options may facilitate the user 102 to adjust schedules based on updated work-study commitments or financial aid considerations. By integrating graduation tracking, adaptive scheduling, and AI-driven query support, the chatbot 402 may ensure that the user 102 (Marco) receives instant, personalized academic guidance, keeping him informed and confident in his pathway to graduation.

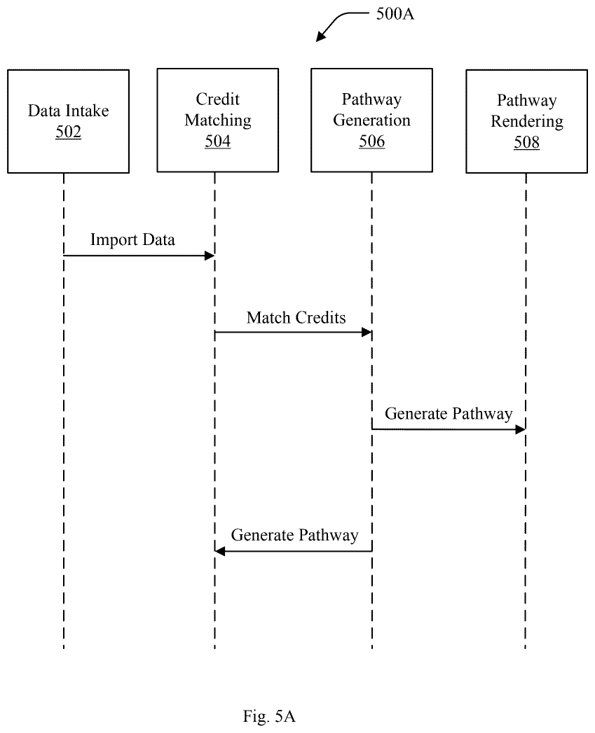

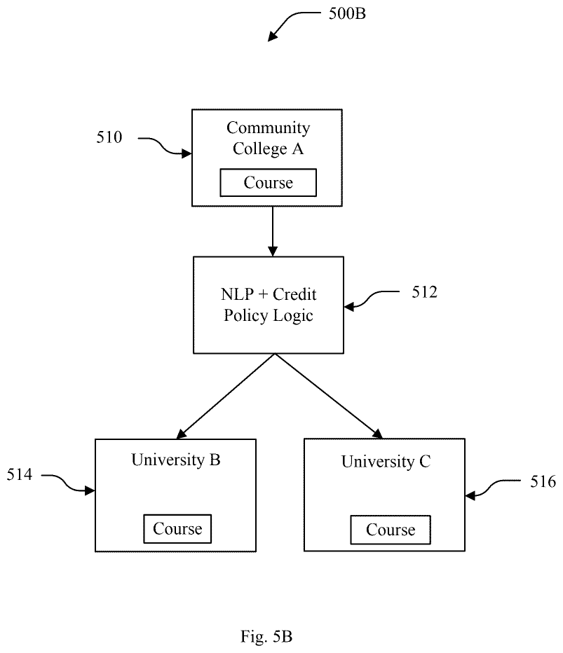

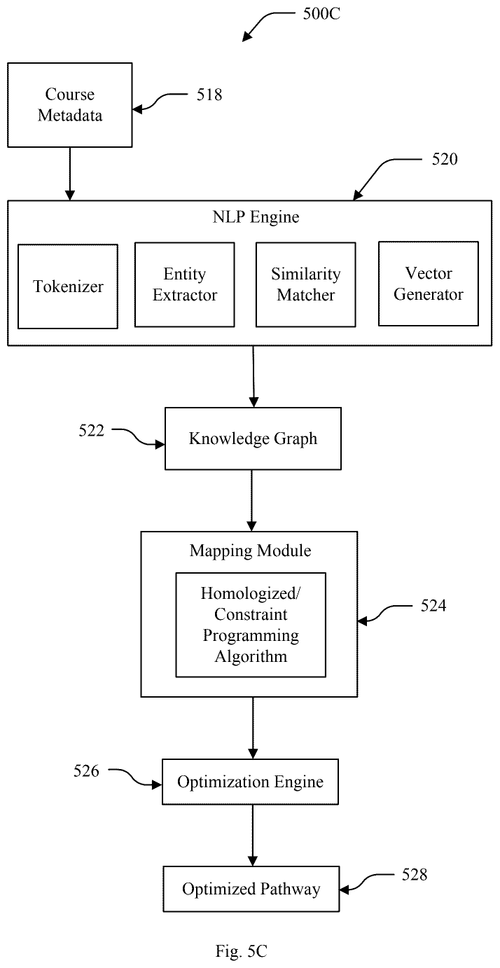

FIG. 5A illustrates a sequence phase diagram 500A outlining the chronological flow of operations involved in generating an optimized academic pathway, in accordance with an embodiment of the present disclosure. The process begins with the intake of user data, as shown by block 502, which may include course completion records, academic goals, and personalized conditions such as credit limits, geographic preferences, and preferred course delivery modes. The data may be provided directly by the user 102 or integrated from institutional systems.

Following data intake, the process enters a credit matching phase, as shown by the block 504. The credit matching phase includes evaluations of the completed courses against potential equivalents across multiple institutions. The evaluation considers course descriptions, learning outcomes, and prerequisite dependencies to identify accurate matches. The credit matching phase ensures that user(s) 102 are not required to retake coursework that is already satisfied through previous academic efforts, promoting efficiency and reducing redundancy.

Once equivalent courses have been identified, the process advances to pathway generation stage, as shown by the block 506. At the pathway generation stage, the system 108 analyzes the remaining academic requirements of the user 102 and assembles a sequenced plan to fulfill them. The sequence is generated logically, accounting for prerequisite chains, co-requisites, credit load balancing, and institutional scheduling constraints. Rolling time windows and academic term alignment may also be considered to ensure that the plan is feasible within the user's targeted timeline.

At pathway rendering phase, as shown by the block 508, the generated academic plan is formatted and displayed on the user interface for interaction. The rendering may include a visual timeline of term-wise course allocation, progress tracking tools, and customization options. Notifications regarding registration deadlines or course availability may also be included. Such comprehensive process facilitates the transformation of fragmented academic records into a structured, optimized, and user-specific academic pathway, supporting both planning and decision-making.

FIG. 5B illustrates an overview of a credit matching logic flow 500B for evaluating and identifying equivalent courses across academic institutions, in accordance with an embodiment of the present disclosure. At step 510, the course offered by Community College A, may be evaluated. The course offered data may include details such as the course title, description, credit hours, learning outcomes, and prerequisite structures. The course offered data may be processed by the layer referred to as “NLP+Credit Policy Logic”, as shown by 512 (hereforth also refred as logic layer). The logic layer combines natural language processing (NLP) techniques with institutional credit policy rules and mapping functions to perform a detailed comparison between the originating course and equivalent offerings at other institutions. The NLP component may extract and analyze key textual attributes from the course description using techniques such as semantic parsing, named entity recognition, and contextual embeddings to understand the instructional intent and academic content of the course. Simultaneously, the policy logic applies institution-specific rules, such as credit hour requirements, acceptable course levels, instructional methodologies, and transfer eligibility thresholds.

Through this combined logic, the system 108 evaluates whether the originating course from Community College A aligns with equivalent courses at University B, shown by 514, or University C, shown by 516. The mapping functions may match based on content similarity, credit weight compatibility, and prerequisite alignment, enabling a structured comparison. Once equivalencies are found, the target courses at the other institutions are flagged as transferable matches, which can then be incorporated into a broader academic pathway for the student. Such automated credit matching logic significantly reduces the time and effort involved in manual equivalency review, ensures greater consistency in transfer evaluations, and enhances the accuracy of cross-institutional course recognition. By integrating NLP with institutional policy frameworks, the process supports scalable and context-aware credit matching in diverse academic environments.

FIG. 5C illustrates an exemplary flow diagram 500C for course metadata processing and optimized academic pathway generation, in accordance with an embodiment of the present disclosure. Course metadata, as shown by 518, including course descriptions, learning outcomes, and academic dependencies is utilized by the natural language processing (NLP) engine, as shown by 520, for analyzing educational content. The NLP engine comprises multiple sub-components, each contributing to the semantic and structural interpretation of academic text. These sub-components include a tokenizer for segmenting course text into meaningful units, an entity extractor to identify key academic concepts, a similarity matcher for comparing course content across institutions, and a vector generator that converts textual data into numerical representations suitable for deeper computational analysis.

The NLP-derived outputs are then forwarded to a knowledge graph, as shown by 522, which encodes the interrelationships between academic concepts, subject domains, skills, and curricular dependencies. The structured representation may allow for the inference of both explicit and implicit connections between courses and academic requirements. By enriching course metadata with semantic links and contextual relationships, the knowledge graph facilitates the system 108 to identify equivalencies across diverse educational frameworks.

Subsequently, the outputs from the knowledge graph are processed by a mapping layer as shown by 524, that applies either a homologized algorithm or a constraint programming algorithm. The algorithms may identify valid course equivalencies, taking into account academic constraints such as prerequisite satisfaction, credit structures, and transfer policies. The result of this mapping process is then passed to an optimization engine, as shown by 526, which analyzes the data in the context of the user's academic goals and personal constraints. The optimization engine generates a tailored academic pathway that balances time, cost, transfer feasibility, and course availability. The final output includes a fully optimized academic pathway, as shown by 528, that offers the most efficient route for the user to achieve their educational objectives.

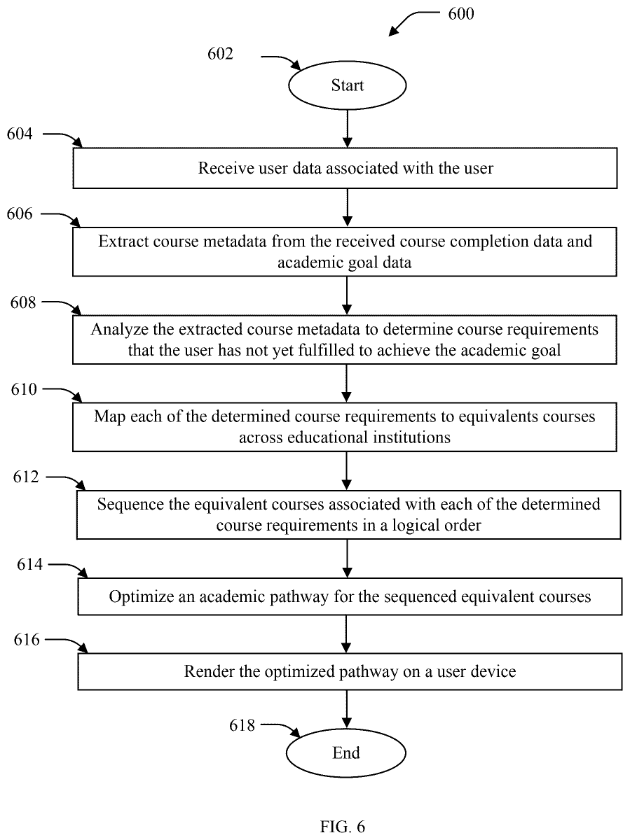

FIG. 6 is a flowchart 600 illustrating a method for optimizing academic pathway for a user to achieve academic goals, in accordance with an embodiment of the present disclosure. The method starts at step 602.

At step 604, the method may include receiving user data associated with the user. The user data may include course completion data, academic goal data, and personalized conditions. The course completion data may include course identifiers, credit values, grade information, and/or current institute metadata. The academic goal data may include target degree, desired major, intended transfer institution, and career objective. The personalized conditions include credit limits, geographic preferences, course availability constraints, preferred course delivery modes, and desired credit load per term.

At step 606, the method may include extracting course metadata from the received course completion data and academic goal data. The course metadata may include course descriptions, learning outcomes, and/or prerequisite dependencies.

At step 608, the method may include analyzing the extracted course metadata to determine course requirements that the user has not yet fulfilled to achieve the academic goal. The analysis may include employing natural language processing (NLP) techniques to analyse the extracted course metadata. The NLP techniques may include named entity recognition, dependency parsing, semantic analysis, and/or contextual embedding models.

At step 610, the method may include mapping each of the determined course requirements to equivalent courses across a plurality of educational institutions. The mappings may be performed via utilizing NLP mapping, knowledge graphs for equivalency mapping, and credit structure matching.

At step 612, the method may include sequencing the equivalent courses associated with each of the determined course requirements in a logical order. The sequencing may be performed by arranging the courses in the correct order to satisfy prerequisite dependencies and co-requisite requirements. Further, the sequencing may be performed by balancing credit loads across academic terms to avoid overload or underload. Furthermore, the sequencing may be performed by ensuring compliance with institutional scheduling constraints, including course availability and enrolment limits. Moreover, the sequencing may be performed by generating a logically ordered pathway that satisfies all course requirements without violating any prerequisite dependencies. In an embodiment, the sequencing of the equivalent courses may be performed by applying rolling time window constraints, ensuring prerequisites are completed within the required academic timeframe.

In an embodiment, sequencing the equivalent courses in the logical order may include arranging the courses in the correct order to satisfy prerequisite dependencies and co-requisite requirements associated with each of the determined course requirements. Further, sequencing the equivalent courses in the logical order may include balancing credit loads across academic terms to avoid overload or underload while ensuring steady progress toward the academic goal. Furthermore, sequencing the equivalent courses in the logical order may include grouping related courses to maintain continuity in subject matter or specialization, thereby enhancing learning outcomes and knowledge retention. Moreover, sequencing the equivalent courses in the logical order may include aligning course sequences with institutional scheduling constraints, including course availability, enrolment limits, and/or term-specific offerings. Additionally, sequencing the equivalent courses in the logical order may include minimizing gaps between sequential courses that require foundational knowledge from prior courses, ensuring timely progression through prerequisite chains.

At step 614, the method may include optimizing an academic pathway for the sequenced equivalent courses based on the personalized conditions. The optimization may be performed by minimizing time to completion by selecting the most efficient sequence of terms while maximizing credit transfer opportunities. Further, the optimization may be performed by reducing cost of attendance by considering tuition fees, financial aid options, and travel expenses. Furthermore, the optimization may be performed by adhering to personalized conditions received from the user. The personalized conditions may include credit limits, geographic preferences, course availability constraints, preferred course delivery modes, and desired credit load per term. Moreover, the optimization may be performed by maximizing the overall efficiency of the pathway by balancing time, cost, credit transfer, and user preferences, thereby generating the most effective and feasible academic plan.

In an embodiment, the method may include generating optimized academic pathway that is both efficient and adaptable to the user specific constraints and preferences. The optimized pathway may include considering credit limits to ensure that the total enrolled credits per term do not exceed or fall below the user's specified constraints. Geographic preferences may be factored in to prioritize course selections at institutions within a preferred location or commuting range. Course availability constraints may be analyzed to align the academic pathway with institutional scheduling, ensuring that required courses are taken in available terms without conflicts. Additionally, preferred course delivery modes, such as in-person, online, or hybrid formats, may be incorporated to match the user 102 learning preferences. Furthermore, desired credit load per term may be optimized to balance academic workload, ensuring steady progress without exceeding personal capacity.

In an embodiment, optimization of the academic pathway may include considering cross-institutional credit transfers, scheduling conflicts, geographic preferences, course delivery modes, travel constraints, financial aid availability, scholarship opportunities, or tuition reimbursement policies relevant to the user.

In an embodiment, optimization of the academic pathway may include multi-institution scheduling. The multi-institution scheduling may be performed by coordinating course schedules across the plurality of educational institutions to ensure that the sequenced equivalent courses can be completed without scheduling conflicts. Further, the multi-institution scheduling may be performed by synchronizing academic terms by aligning start and end dates across the plurality of educational institutions. Furthermore, the multi-institution scheduling may be performed by maximizing credit transfer by selecting course combinations that fulfil the determined course requirements while satisfying cross-institutional credit transfer policies. Moreover, the multi-institution scheduling may be performed by minimizing travel requirements by prioritizing course selections that reduce commuting time when multiple institutions are involved.

At step 616, the method may include rendering the optimized pathway on a user device. The rendering may include displaying the cross-institutional course schedule with a detailed timeline showing the sequence of terms and corresponding courses. Further, the rendering may include providing interactive visual elements that allow the user to view prerequisites, co-requisites, credit values, and course delivery modes. Furthermore, the rendering includes enabling user customization by allowing the user to adjust course selections, credit loads, or preferred institutions directly through the interface. Moreover, the rendering may include generating a summary of progress toward the academic goal, including an overview of completed, in-progress, and upcoming courses required to achieve the goal. Additionally, the rendering may include generating customized notifications to the user regarding registration deadlines, course availability updates, and prerequisite completion requirements associated with the optimized academic pathway. The method ends at step 618.

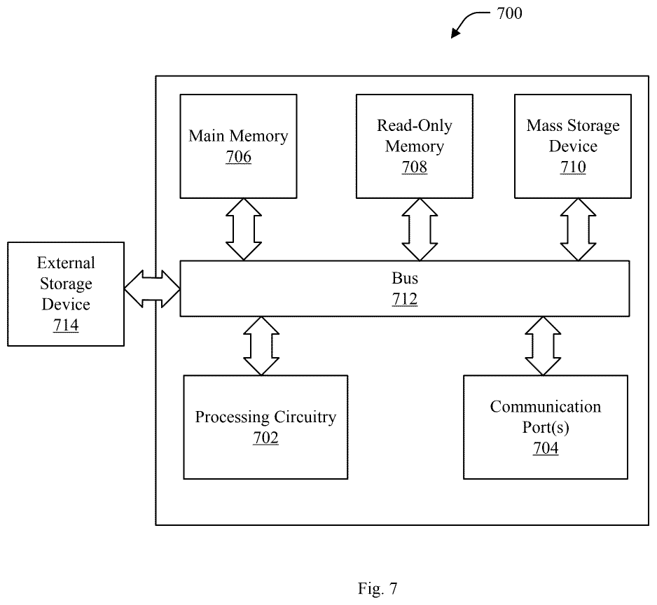

FIG. 6 illustrates an exemplary computer system 700 in which or with which embodiments of the present disclosure may be utilized. As shown in FIG. 7, a computer system 700 includes an external storage device 714, a bus 712, a main memory 706, a read-only memory 708, a mass storage device 710, a communication port 704, and a processor 702.

Those skilled in the art will appreciate that computer system 700 may include more than one processor 702 and communication ports 704. Examples of processor 702 include, but are not limited to, an Intel® Itanium® or Itanium 2 processor(s), or AMD® Opteron® or Athlon MP® processor(s), Motorola® lines of processors, FortiSOC™ system on chip processors, or other future processors. The processor 702 may include various modules associated with embodiments of the present disclosure.

The communication port 704 can be any of an RS-232 port for use with a modem-based dial-up connection, a 10/100 Ethernet port, a Gigabit or 10 Gigabit port using copper or fiber, a serial port, a parallel port, or other existing or future ports. The communication port 604 may be chosen depending on a network, such as a Local Area Network (LAN), Wide Area Network (WAN), or any network to which the computer system connects.

The memory 706 can be Random Access Memory (RAM) or any other dynamic storage device commonly known in the art. Read-Only Memory 708 can be any static storage device(s), e.g., but not limited to, a Programmable Read-Only Memory (PROM) chips for storing static information, e.g., start-up or BIOS instructions for processor 702.

The mass storage 710 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

The bus 712 communicatively couples processor(s) 702 with the other memory, storage, and communication blocks. The bus 712 can be, e.g., a Peripheral Component Inter-connect (PCI)/PCI Extended (PCI-X) bus, Small Computer System Interface (SCSI), USB, or the like, for connecting expansion cards, drives, and other subsystems as well as other buses, such a front side bus (FSB), which connects processor 702 to a software system.

Optionally, operator and administrative interfaces, e.g., a display, keyboard, and a cursor control device, may also be coupled to bus 712 to support direct operator interaction with the computer system. Other operator and administrative interfaces can be provided through network connections connected through communication port 704. An external storage device 714 can be any kind of external hard-drives, floppy drives, IOMEGA® Zip Drives, Compact Disc Read-Only Memory (CD-ROM), Compact Disc-Re-Writable (CD-RW), Digital Video Disk Read Only Memory (DVD-ROM). The components described above are meant only to exemplify various possibilities. In no way should the aforementioned exemplary computer system limit the scope of the present disclosure.

One or more embodiments of the present disclosure relate to a system and method (together termed as mechanism) for optimizing academic pathway for a user to achieve academic goals. The disclosed mechanism provides a transformative approach to optimizing academic pathways by leveraging advanced artificial intelligence (AI), predictive analytics, and real-time adaptability. The mechanism addresses the limitations of traditional academic planning, which often lacks personalization, efficiency, and adaptability. By integrating cutting-edge AI techniques, such as hierarchical knowledge graphs, multi-objective optimization algorithms, and natural language processing (NLP), the mechanism ensures that students receive precise, data-driven recommendations tailored to their academic and career goals.

A key advantage of the mechanism is its ability to dynamically adjust to real-time institutional changes, including course availability, transfer credit policies, and evolving degree requirements. Unlike static academic advising tools, this mechanism continuously refines pathways based on institutional updates and user modifications, ensuring optimal scheduling and credit utilization. Additionally, the mechanism incorporates a multi-institution scheduling feature, allowing students to seamlessly coordinate coursework across multiple institutions while minimizing scheduling conflicts, travel constraints, and financial burdens.

The mechanism's AI-driven decision-making enhances efficiency by automating complex tasks such as course equivalency determination, graduation readiness evaluation, and academic scheduling. The use of domain-specific embeddings and NLP techniques ensures accurate course mappings, even in cases where direct articulation agreements are unavailable. This reduces redundancy in coursework, accelerates time to graduation, and improves overall academic success rates. Moreover, the mechanism includes a real-time user interaction framework, such as an AI-powered chatbot, which allows students to receive instant guidance, explore alternative academic scenarios, and make informed decisions based on predictive insights.

The optimization engine further ensures scalability by employing hybridized constraint propagation algorithms and genetic algorithms customized for academic scheduling. These techniques facilitate the mechanism to efficiently handle large datasets, ensuring rapid response times even for complex multi-semester, multi-institutional academic planning scenarios. Furthermore, the integration of explainable AI enhances transparency by providing clear justifications for pathway recommendations, fostering trust among students, advisors, and educational institutions.

Overall, the invention sets a new standard in academic advising and planning by delivering a scalable, AI-driven, and highly adaptable solution that prioritizes efficiency, personalization, and transparency. Through advanced data analytics, automated optimization, and real-time adaptability, the mechanism empowers students to achieve their academic goals with greater confidence and efficiency while enabling institutions to improve student success outcomes.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . . And N, the text should be interpreted as requiring only one element from the group, not A plus N, or B plus N, etc.

While the foregoing describes various embodiments of the disclosure, other and further embodiments of the disclosure may be devised without departing from the basic scope thereof. The scope of the disclosure is determined by the claims that follow. The disclosure is not limited to the described embodiments, versions, or examples, which are included to enable a person having ordinary skill in the art to make and use the disclosure when combined with information and knowledge available to the person having ordinary skill in the art.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

While the foregoing describes various embodiments of the disclosure, other and further embodiments of the disclosure may be devised without departing from the basic scope thereof. The scope of the disclosure is determined by the claims that follow. The disclosure is not limited to the described embodiments, versions, or examples, which are included to enable a person having ordinary skill in the art to make and use the disclosure when combined with information and knowledge available to the person having ordinary skill in the art.

What is claimed is:

1. A system for optimizing academic pathway for a user to achieve academic goals, the system comprising:
a receiver module to receive user data associated with the user, the user data comprising:
course completion data, academic goal data, and personalized conditions;
an extraction module to extract course metadata from the received course completion data and academic goal data, the course metadata comprising at least one of: course descriptions, learning outcomes, and prerequisite dependencies;
an analysis module to analyze the extracted course metadata to determine one or more course requirements that the user has not yet fulfilled to achieve the academic goal;
a mapping module to map each of the determined one or more course requirements to one or more equivalent courses across a plurality of educational institutions;
a sequencing module to sequence the one or more equivalent courses associated with each of the determined one or more course requirements in a logical order;
an optimization module to optimize an academic pathway for the sequenced one or more equivalent courses based on the received personalized conditions; and
a rendering module to render the optimized pathway on a user device.

2. The system as claimed in claim 1,
wherein the course completion data comprises course identifiers, credit values, grade information, and current institute metadata;
wherein the academic goal data comprises at least one of: target degree, desired major, intended transfer institution, and career objectives; and
wherein the personalized conditions comprises at least one of: credit limits, geographic preferences, course availability constraints, preferred course delivery modes and desired credit load per term.

3. The system as claimed in claim 1, wherein the sequencing is performed by at least one of:
arranging the courses in the correct order to satisfy prerequisite dependencies and co-requisite requirements;
balancing credit loads across academic terms to avoid overload or underload;
ensuring compliance with institutional scheduling constraints, including course availability and enrolment limits; and
generating the logically ordered pathway that satisfies all course requirements without violating any prerequisite dependencies.

4. The system as claimed in claim 1, wherein the optimization is performed by at least one of:
minimizing time to completion by selecting the most efficient sequence of terms while maximizing credit transfer opportunities;
reducing cost of attendance by considering tuition fees, financial aid options, and travel expenses;
adhering to personalized conditions received from the user, including geographic preferences, preferred course delivery modes, and desired credit load per term; and
maximizing the overall efficiency of the pathway by balancing time, cost, credit transfer, and user preferences, thereby generating the most effective and feasible academic plan.

5. The system as claimed in claim 1, wherein the rendering comprises:
displaying the cross-institutional course schedule with a detailed timeline showing the sequence of terms and corresponding courses;
providing interactive visual elements that allow the user to view prerequisites, co-requisites, credit values, and course delivery modes;
enabling user customization by allowing the user to adjust course selections, credit loads, or preferred institutions directly through the interface;
generating a summary of progress toward the academic goal, including an overview of completed, in-progress, and upcoming courses required to achieve the goal; and
generating customized notifications to the user regarding registration deadlines, course availability updates, and prerequisite completion requirements associated with the optimized academic pathway.

6. The system as claimed in claim 1, wherein the analysis comprises employing natural language processing (NLP) techniques to analyse the extracted course metadata, wherein the NLP techniques comprises at least one of: named entity recognition, dependency parsing, semantic analysis, and contextual embedding models.

7. The system as claimed in claim 1, wherein the sequencing of the one or more equivalent courses is performed by applying rolling time window constraints, ensuring prerequisites are completed within the required academic timeframe.

8. The system as claimed in claim 1,
wherein optimization of the academic pathway includes considering at least one of:
cross-institutional credit transfers, scheduling conflicts, geographic preferences, course delivery modes, travel constraints, financial aid availability, scholarship opportunities, or tuition reimbursement policies relevant to the user; and
wherein optimization of the academic pathway includes multi-institution scheduling, wherein multi-institution scheduling is performed via at least one of:
coordinating course schedules across the plurality of educational institutions to ensure that the sequenced one or more equivalent courses can be completed without scheduling conflicts;
synchronizing academic terms by aligning start and end dates across the plurality of educational institutions;
maximizing credit transfer by selecting course combinations that fulfil the determined course requirements while satisfying cross-institutional credit transfer policies; and
minimizing travel requirements by prioritizing course selections that reduce commuting time when multiple institutions are involved.

9. The system as claimed in claim 1, the mapping is performed utilizing at least one of: NLP mapping, knowledge graphs for equivalency mapping, and credit structure matching.

10. The system as claimed in claim 1, wherein sequencing the one or more equivalent courses in the logical order comprises at least one of:
arranging the courses in the correct order to satisfy prerequisite dependencies and co-requisite requirements associated with each of the determined one or more course requirements;
balancing credit loads across academic terms to avoid overload or underload while ensuring steady progress toward the academic goal;
grouping related courses to maintain continuity in subject matter or specialization, thereby enhancing learning outcomes and knowledge retention;
aligning course sequences with institutional scheduling constraints, including course availability, enrolment limits, and term-specific offerings; and
minimizing gaps between sequential courses that require foundational knowledge from prior courses, ensuring timely progression through prerequisite chains.

11. A method for optimizing academic pathway for a user to achieve academic goals, the method comprising:
receiving user data associated with the user, the user data comprising: course completion data, academic goal data, and personalized conditions;
extracting course metadata from the received course completion data and academic goal data, the course metadata comprising at least one of: course descriptions, learning outcomes, and prerequisite dependencies;
analyzing the extracted course metadata to determine one or more course requirements that the user has not yet fulfilled to achieve the academic goal;
mapping each of the determined one or more course requirements to one or more equivalent courses across a plurality of educational institutions;
sequencing the one or more equivalent courses associated with each of the determined one or more course requirements in a logical order;
optimizing an academic pathway for the sequenced one or more equivalent courses based on the received personalized conditions; and
rendering the optimized pathway on a user device.

12. The method as claimed in claim 11,
wherein the course completion data comprises course identifiers, credit values, grade information, and current institute metadata;
wherein the academic goal data comprises at least one of: target degree, desired major, intended transfer institution, and career objectives; and
wherein the personalized conditions comprises at least one of: credit limits, geographic preferences, course availability constraints, preferred course delivery modes and desired credit load per term.

13. The method as claimed in claim 11, wherein the sequencing is performed by at least one of:
arranging the courses in the correct order to satisfy prerequisite dependencies and co-requisite requirements;
balancing credit loads across academic terms to avoid overload or underload;
ensuring compliance with institutional scheduling constraints, including course availability and enrolment limits; and
generating the logically ordered pathway that satisfies all course requirements without violating any prerequisite dependencies.

14. The method as claimed in claim 11, wherein the optimization is performed by at least one of:
minimizing time to completion by selecting the most efficient sequence of terms while maximizing credit transfer opportunities;
reducing cost of attendance by considering tuition fees, financial aid options, and travel expenses;
adhering to personalized conditions received from the user, including geographic preferences, preferred course delivery modes, and desired credit load per term; and
maximizing the overall efficiency of the pathway by balancing time, cost, credit transfer, and user preferences, thereby generating the most effective and feasible academic plan.

15. The method as claimed in claim 11, wherein the rendering comprises:
displaying the cross-institutional course schedule with a detailed timeline showing the sequence of terms and corresponding courses;
providing interactive visual elements that allow the user to view prerequisites, co-requisites, credit values, and course delivery modes;
enabling user customization by allowing the user to adjust course selections, credit loads, or preferred institutions directly through the interface;
generating a summary of progress toward the academic goal, including an overview of completed, in-progress, and upcoming courses required to achieve the goal; and
generating customized notifications to the user regarding registration deadlines, course availability updates, and prerequisite completion requirements associated with the optimized academic pathway.

16. The method as claimed in claim 11, wherein the analysis comprises employing natural language processing (NLP) techniques to analyse the extracted course metadata, wherein the NLP techniques comprises at least one of: named entity recognition, dependency parsing, semantic analysis, and contextual embedding models.

17. The method as claimed in claim 11, wherein the sequencing of the one or more equivalent courses is performed by applying rolling time window constraints, ensuring prerequisites are completed within the required academic timeframe.

18. The method as claimed in claim 11,
wherein optimization of the academic pathway includes considering at least one of:
cross-institutional credit transfers, scheduling conflicts, geographic preferences, course delivery modes, travel constraints, financial aid availability, scholarship opportunities, or tuition reimbursement policies relevant to the user; and
wherein optimization of the academic pathway includes multi-institution scheduling, wherein multi-institution scheduling is performed via at least one of:
coordinating course schedules across the plurality of educational institutions to ensure that the sequenced one or more equivalent courses can be completed without scheduling conflicts;
synchronizing academic terms by aligning start and end dates across the plurality of educational institutions;
maximizing credit transfer by selecting course combinations that fulfil the determined course requirements while satisfying cross-institutional credit transfer policies; and
minimizing travel requirements by prioritizing course selections that reduce commuting time when multiple institutions are involved.

19. The method as claimed in claim 11, the mapping is performed utilizing at least one of: NLP mapping, knowledge graphs for equivalency mapping, and credit structure matching.

20. The method as claimed in claim 11, wherein sequencing the one or more equivalent courses in the logical order comprises at least one of:
arranging the courses in the correct order to satisfy prerequisite dependencies and co-requisite requirements associated with each of the determined one or more course requirements;
balancing credit loads across academic terms to avoid overload or underload while ensuring steady progress toward the academic goal;
grouping related courses to maintain continuity in subject matter or specialization, thereby enhancing learning outcomes and knowledge retention;
aligning course sequences with institutional scheduling constraints, including course availability, enrolment limits, and term-specific offerings; and
minimizing gaps between sequential courses that require foundational knowledge from prior courses, ensuring timely progression through prerequisite chains.
